(19) United States
(12) Patent Application Publication
(10) Pub. No.: US 2022/0261724 A1
(43) Pub. Date: Aug. 18, 2022

(54) COMPUTER-READABLE RECORDING MEDIUM STORING INFORMATION PROCESSING PROGRAM, INFORMATION PROCESSING METHOD, AND INFORMATION PROCESSING DEVICE

(71) Applicant: FUJITSU LIMITED, Kawasaki-shi (JP)

(72) Inventor: Ken Iizawa, Yokohama (JP)

(73) Assignee: FUJITSU LIMITED, Kawasaki-shi (JP)

(21) Appl. No.: 17/524,773

(22) Filed: Nov. 12, 2021

(30) Foreign Application Priority Data
Feb. 18, 2021 (JP) 2021-023978

(51) Int. Cl. G06Q 10/06; G06F 16/28; G06F 16/23; G06F 11/34

(52) U.S. Cl. CPC G06Q 10/06315; G06F 16/282; G06F 11/3409; G06F 16/2358; G06F 16/285

(57) ABSTRACT

A non-transitory computer-readable recording medium stores an information processing program for causing a computer to execute processing including: classifying a database file into a plurality of datasets; generating an object on the basis of the classified dataset; and dividing and arranging each of the generated objects into layers that have different management conditions in an object storage.

### CROSS-REFERENCE TO RELATED APPLICATION

This application is based upon and claims the benefit of priority of the prior Japanese Patent Application No. 2021-23978, filed on Feb. 18, 2021, the entire contents of which are incorporated herein by reference.

### FIELD

The embodiments discussed herein are related to an information processing program, an information processing method, and an information processing device.

### BACKGROUND

With an explosive increase in a data amount regarding today's computing and an increase in non-traditional types of data, a storage is required to have a function different from traditional functions. In the period when processing is mainly executed on small files, a file system having a directory structure has been effective. However, an increase in the number of pieces of data such as moving image files causes a bottleneck in input/output (I/O) of the storage. As one of technologies for solving such problems, an object storage attracts attention.

Japanese Laid-open Patent Publication No. 2003-108317, Japanese Laid-open Patent Publication No. 2009-110451, and International Publication Pamphlet No. WO 2016/147279 are disclosed as related art.

### SUMMARY

According to an aspect of the embodiments, a non-transitory computer-readable recording medium stores an information processing program for causing a computer to execute processing including: classifying a database file into a plurality of datasets; generating an object on the basis of the classified dataset; and dividing and arranging each of the generated objects into layers that have different management conditions in an object storage.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of a storage system;

FIG. 2 is a block diagram illustrating details of a gateway according to a first embodiment;

FIG. 3 is a diagram illustrating an example of a database file;

FIG. 4 is a diagram illustrating a storage state of a database file in the first embodiment;

FIG. 5 is a flowchart of storage processing to an object storage by the gateway according to the first embodiment;

FIG. 6 is a block diagram illustrating details of a gateway according to a second embodiment;

FIG. 7 is a diagram illustrating a storage state to a first layer of a database file according to the second embodiment;

FIG. 8 is a flowchart of storage processing to an object storage by the gateway according to the second embodiment;

FIG. 9 is a diagram illustrating a storage example in a case where a column group with a high access frequency is equally divided into an optimum division size to form an object;

FIG. 10 is a diagram illustrating a storage example in a case where each column in a column group with a high access frequency is assumed as a single object; and

FIG. 11 is a diagram illustrating an example of a hardware configuration of a gateway.

### DESCRIPTION OF EMBODIMENTS

The object storage handles data in object units, not in file units or block units. In the object storage, a layer structure such as a directory does not exist, and a container of an object called a storage pool is created and is managed according to metadata. The objects have a flat relationship, and the layer structure does not change due to the movement of the data. Furthermore, the number of objects is not limited. In this way, unlike a file storage that performs management with a directory structure, the object storage does not have a storage limit of a data size and the number of pieces of data. Therefore, the object storage is suitable for storing a large capacity data. Therefore, the object storage is widely used as an inexpensive storage suitable for long-term storage.

The object storage generally receives a request from a client via a component called a gateway. The request is a pair of an object name that the client desires to access and an operation on the object name. The operation is, for example, an object interface such as Put or Get.

Moreover, some object storages hold structured data including rows and columns as a dataset of a database file. The structured data including rows and columns has, for example, a column-directed format in which the same column is stored in a continuous region on a storage medium. As a specific storage method, in the structured data in the column-directed format, data included in each column is stored in continuous addresses on the storage medium in an order in the column.

Furthermore, an application that uses data in the object storage, for example, accesses a database file stored in the object storage via a database management system (DBMS). The application accesses the DBMS using a standardized application programming interface (API) such as a structured query language (SQL). The object storage includes an index in which a storage position of each column on the storage medium is recorded. The database management system may directly read each column by referring to the index.

In a case where the application that accesses the structured data in the column-directed format via the DBMS is used, the access to the data has the following characteristics. Such an application accesses some columns, not the entire file. As a result, an access frequency of each column is different. For example, a column group with a high access frequency and a column group with a low access frequency are generated in the database file. The column group with the high access frequency may be further classified into a plurality of groups that is accessed at the same time.

Here, there is a case where the object storage is divided into layers and used according to a purpose. For example, a service using the object storage includes a public cloud storage with a pay-as-you-go system. Fees that occur in the public cloud storage include an “access fee” charged for an access to the object storage and a “storage fee” charged for a storage data amount. For example, a unit of the access fee is yen per access, and a unit of the storage fee is GB·month per yen. Then, in the public cloud storage, for example, two layers having the same performance and different rate plans are prepared. A first layer that is a first layer has a high storage fee and a low access fee, and a second layer that is a second layer has a low storage fee and a high access fee.

In such a public cloud storage, a gateway may have the following two functions. The first is a function, called a profiler (profiler), that analyzes an access history such as Put or Get with respect to an object stored in an object storage and specifies an object with a high access frequency. The second is a function, called a data mover (data mover), that periodically moves the object that is specified by the profiler and has a high access frequency from the second layer to the first layer. However, because the client accesses the data via the gateway, the client may access the data without being aware of a layer where the object exists.

Note that, as related art regarding data access, there is a technique for investigating an access frequency for each data block, moving the data block to a storage device in a high-performance group in a case where the access frequency exceeds a predetermined upper limit, and moving the data block to a storage device in a low-performance group in a case where the access frequency falls below the lower limit. Furthermore, there is a technique for classifying data into data with a high access frequency and data with a low access frequency, concentrating a region where the data with the high access frequency is stored on a specific drive, and setting a drive for storing the data with the low access frequency as a sleeve so as to save power. Moreover, there is a technique for monitoring a relevance between pieces of data on the basis of the access frequency for each pair of pieces of data continuously accessed in response to an access request to the storage device and executing data arrangement processing on the basis of a temporal change in a tendency of a relevance distribution.

However, traditionally, the entire database file has been collectively stored in the first layer or the second layer according to the access frequency as a single object. This is because an access unit in the access history that has been traditionally acquired by the profiler has been an entire file. Traditionally, in a case where the profiler determines that the access frequency to the database file is higher than a specific threshold, the database file is stored in the first layer, and in a case where the profiler determines that the access frequency is lower than the specific threshold, the database file is stored in the second layer. In this case, there is a possibility that the following problems occur.

In a case where the database file is stored in the first layer, a column with a low access frequency is also stored in the first layer. Therefore, although the column with the low access frequency does not receive benefits of the first layer such that the first layer has the low access fee, the storage cost increases. Furthermore, in a case where the database file is stored in the second layer, a column with a high access frequency is also stored in the second layer. Therefore, because the column with the high access frequency has a high access fee in the second layer, the cost increases. In this way, with the traditional storage technique to the object storage, it has been difficult to appropriately arrange data in order to sufficiently receive benefits by dividing a storage location into layers.

These are similar to the data access technique for moving the data to the high-performance group storage device or the low-performance group storage device according to the access frequency and the data access technique for concentrating the region where the data with the high access frequency is stored on the specific drive. Furthermore, even if the technique for arranging data on the basis of the access frequency for each pair of pieces of data is used, the appropriate data arrangement and object handling according to the conditions of the storage location are not considered, and similar problems occur.

The disclosed technology has been made in consideration of the above, and an object is to provide an information processing program, an information processing method, and an information processing device that appropriately arrange data in an object storage.

Embodiments of an information processing program, an information processing method, and an information processing device disclosed by the present application will be described in detail below with reference to the drawings. Note that the following embodiments do not limit the information processing program, the information processing method, and the information processing device disclosed in the present application.

### First Embodiment

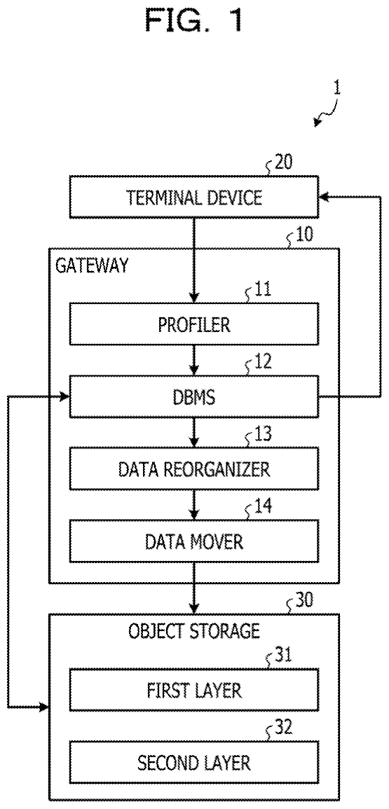

FIG. 1 is a block diagram of a storage system. A storage system 1 includes a gateway 10, a terminal device 20, and an object storage 30.

In the terminal device 20, an application using a database file stored in the object storage 30 operates. The application that operates in the terminal device 20 transmits a request to the object storage 30 via the gateway 10 so as to read from and write to the database file. The request designates a column of objects to be accessed. For example, in response to the request, an offset of the object to be accessed is designated, and a column to be accessed is designated according to the value of the offset.

The object storage 30 is a storage that uses data in object units. The object storage 30 includes two regions including a first layer 31 and a second layer 32 as regions where data is managed. A data management condition in the first layer 31 is different from that in the second layer 32.

For example, the object storage 30 according to the present embodiment is a public cloud storage with a pay-as-you-go system. Although performances of the first layer 31 and the second layer 32 are the same, rate plans are different. In the first layer 31, a data storage fee is high, and a data access fee is low. Furthermore, in the second layer 32, a data storage fee is low, and a data access fee is high.

The object storage 30 receives an instruction from a data mover 14 included in the gateway 10 and arranges data in one of the first layer 31 or the second layer 32 for each object. Then, the object storage 30 notifies a DBMS 12 included in the gateway 10 to be described later of information regarding a position of a column included in each arranged object. Furthermore, the object storage 30 receives a request from the DBMS 12 included in the gateway 10 and reads or writes the designated object from or to the first layer 31 or the second layer 32 where each object is stored.

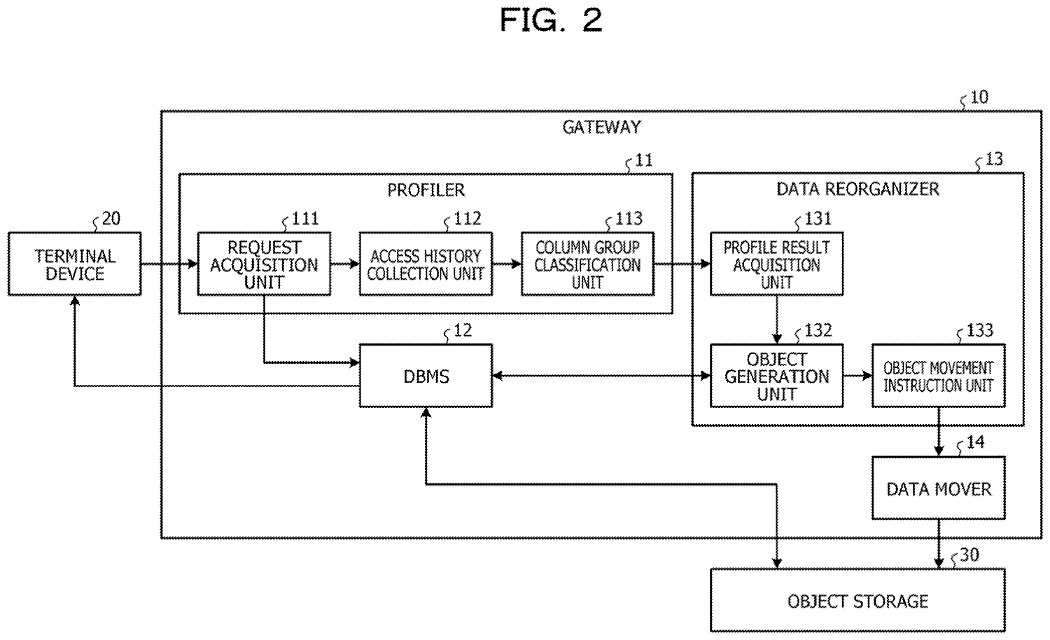

The gateway 10 mediates data transmission and reception between the terminal device 20 and the object storage 30. Furthermore, the gateway 10 manages arrangement of the database files between the first layer 31 and the second layer 32 in the object storage 30. The gateway 10 includes a profiler 11, the DBMS 12, a data reorganizer 13, and the data mover 14. FIG. 2 is a block diagram illustrating details of a gateway according to the first embodiment. The details of the gateway 10 will be described with reference to FIG. 2.

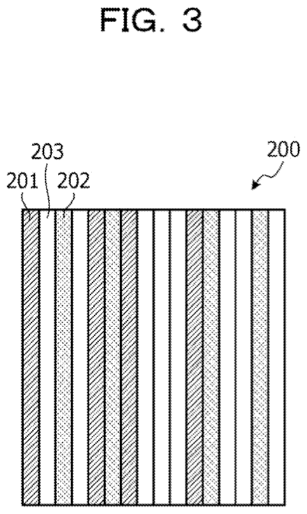

FIG. 3 is a diagram illustrating an example of a database file. Here, an example of a case of using a database file 200 illustrated in FIG. 3 will be described. The database file 200 is structured data, of which the number of columns is 16, in a column-directed format. In an initial state, the database file 200 may be stored in the object storage 30 in any state. Here, as an example, a state where the database file 200 is collectively stored in the first layer 31 or the second layer 32 as a single object will be described as an initial state.

Returning to FIG. 2, description is continued. The profiler 11 determines an access status of each column on the basis of an access history to each column of the database file 200. The profiler 11 includes a request acquisition unit 111, an access history collection unit 112, and a column group classification unit 113.

The request acquisition unit 111 acquires a request that is transmitted from the terminal device 20 and requests an access to the database file 200. Then, the request acquisition unit 111 outputs the acquired request to the access history collection unit 112 and the DBMS 12.

The access history collection unit 112 receives an input of the request from the request acquisition unit 111. Then, the access history collection unit 112 collects and accumulates information regarding a column to be accessed in an object designated by the request. Here, in a case where a saved access history exceeds a size of a storage region, the access history collection unit 112 deletes the access history from the oldest one and adds new information.

The column group classification unit 113 has an access frequency threshold used to classify columns to be stored in the first layer 31 and the second layer 32 of the object storage 30 in advance. The column group classification unit 113 acquires the access history periodically, for example, a fixed time once a day, from the access history collection unit 112. Then, the column group classification unit 113 analyzes the acquired access history and obtains an access frequency of each column of the database file 200.

Next, the column group classification unit 113 compares an access frequency and an access frequency threshold of each column and extracts a column of which the access frequency is equal to or more than the access frequency threshold as a column with a high access frequency. For example, in the database file 200 in FIG. 3, the column group classification unit 113 extracts a column 201 represented by a diagonal line pattern and a column 202 represented by a dot pattern as a column with a high access frequency.

Furthermore, the column group classification unit 113 extracts a column of which the access frequency is less than the access frequency threshold as a column with a low access frequency. For example, in the database file 200 of FIG. 3, the column group classification unit 113 extracts a column 203 represented by a plain pattern as a column with a low access frequency.

Then, the column group classification unit 113 outputs a profile result obtained by classifying the database file 200 into columns with a high access frequency and columns with a low access frequency to the data reorganizer 13.

The DBMS 12 includes an index representing a position of each column of the object forming the database file 200 in the object storage 30. The DBMS 12 receives an input of the request for requesting the access to the database file 200 from the request acquisition unit 111. Next, the DBMS 12 acquires information regarding an object designated by the request and its column. Next, the DBMS 12 specifies a position of the column of the object to be accessed in the object storage 30 referring to the index. Then, the DBMS 12 executes processing designated by the request on data of the database file 200 stored at the specified position. For example, in a case where the request is a Get command, the DBMS 12 acquires the data of the database file 200 stored at the specified position from the object storage 30. Then, the DBMS 12 returns a response to the terminal device 20 that is a transmission source of the request.

Furthermore, the DBMS 12 receives an acquisition request of information regarding each column included in the database file 200 from an object generation unit 132. Then, the DBMS 12 acquires the information indicating the position of each column included in the database file 200 in the object storage 30 from the index and outputs the information to the object generation unit 132. Thereafter, the DBMS 12 acquires the information indicating the position of each column of each object after movement from the object storage 30 and updates the index.

The data reorganizer 13 creates a plurality of objects by dividing the database file 200 according to an access frequency of each column and stores each object in the first layer 31 or the second layer 32 in the object storage 30. The data reorganizer 13 includes a profile result acquisition unit 131, the object generation unit 132, and an object movement instruction unit 133.

The profile result acquisition unit 131 acquires an input of a profile result indicating a classification result according to the access frequency of each column of the database file 200 from the column group classification unit 113. Next, the profile result acquisition unit 131 outputs the acquired profile result to the object generation unit 132.

The object generation unit 132 receives the input of the profile result indicating the classification result according to the access frequency of each column of the database file 200 from the profile result acquisition unit 131. Furthermore, the object generation unit 132 issues an acquisition request of the information regarding each column included in the database file 200 to the DBMS 12. Thereafter, the object generation unit 132 acquires the information indicating the position of each column included in the database file 200 in the object storage 30 from the DBMS 12.

Then, the object generation unit 132 divides the database file 200 for each column using the information regarding each column acquired from the DBMS 12 and collectively set the columns with a high access frequency as a single object. Moreover, the object generation unit 132 determines that an arrangement destination of the object is the first layer 31. Furthermore, the object generation unit 132 divides the database file 200 for each column using the information regarding each column acquired from the DBMS 12 and collectively sets the columns with a low access frequency as a single object. Moreover, the object generation unit 132 determines that an arrangement destination of the object is the second layer 32.

Thereafter, the object generation unit 132 outputs information regarding an object including information indicating a column included in each object and information regarding a layer in which each object is arranged to the object movement instruction unit 133. For example, the object generation unit 132 outputs the information regarding the object including the column group with the high access frequency and the information for designating the first layer 31 as the arrangement destination of the object to the object movement instruction unit 133. Furthermore, the object generation unit 132 outputs the information regarding the object including the column group with a low access frequency and the information for designating the second layer 32 as the arrangement destination of the object to the object movement instruction unit 133.

The object movement instruction unit 133 receives information regarding the object generated by the object generation unit 132 and an input to a layer that is a storage destination of each object. Then, the object movement instruction unit 133 instructs the data mover 14 to store each object in the designated layer.

The data mover 14 receives the instruction to store each object from the object movement instruction unit 133. Then, the data mover 14 collectively moves the columns of the database file 200 included in each object to the designated layer in the object storage 30 and stores the columns as an object. For example, the data mover 14 moves the object in the column group with the high access frequency to the first layer 31 and moves the object in the column group with the low access frequency to the second layer 32.

For example, in a case where the object storage 30 is a pay-as-you-go public cloud storage, the gateway 10 sets a layer of which a storage fee is high and an access fee is low as the first layer 31 and sets a layer of which a storage fee is low and an access fee is high as the second layer 32. Then, the gateway 10 stores the object including the column group with the high access frequency in the first layer 31 and stores the object including the column group with the low access frequency in the second layer 32.

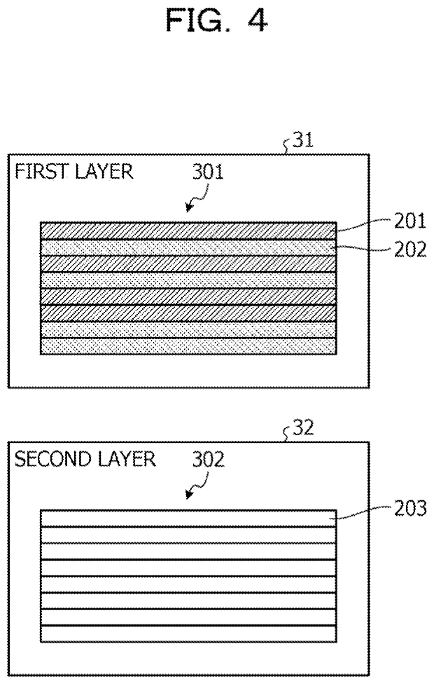

FIG. 4 is a diagram illustrating a storage state of a database file in the first embodiment. For example, in the database file 200 illustrated in FIG. 3, the columns 201 and 202 with a high access frequency are collectively stored in the first layer 31 as a single object 301. Furthermore, the column 203 with the low access frequency is collectively stored in the second layer 32 as a single object.

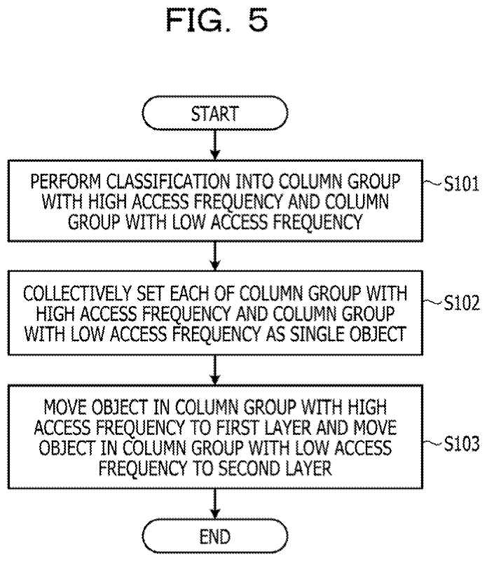

Next, with reference to FIG. 5, a flow of processing for storing the database file 200 in the object storage 30 by the gateway 10 according to the present embodiment will be described. FIG. 5 is a flowchart of storage processing to the object storage by the gateway according to the first embodiment.

The profile result acquisition unit 131 acquires an access frequency of each column from the access history collection unit 112. Then, the profile result acquisition unit 131 compares the access frequency and an access frequency threshold of each column and classifies the columns into columns having the access frequency equal to or more than the access frequency threshold and the high access frequency and columns having the low access frequency less than the access frequency threshold (step S101).

The profile result acquisition unit 131 acquires an input of a profile result indicating a classification result according to the access frequency of each column of the database file 200 from the column group classification unit 113. Then, the profile result acquisition unit 131 outputs the acquired profile result to the object generation unit 132. The object generation unit 132 divides the database file 200 for each column using the information regarding each column acquired from the DBMS 12 and collectively sets each of the columns with the high access frequency and the columns with the low access frequency into a single object (step S102).

The object generation unit 132 outputs information regarding an object including information indicating a column included in each object and information regarding a layer in which each object is arranged to the object movement instruction unit 133. The object movement instruction unit 133 instructs the data mover 14 to store each object in the designated layer. The data mover 14 moves the object in the column group with the high access frequency to the first layer 31 and moves the object in the column group with the low access frequency to the second layer 32 (step S103).

As described above, the storage system according to the present embodiment classifies data according to the access frequency of each column of the structured data in the column-directed format, individually generates the object, and stores the respective objects in layers having different management conditions. As a result, it is possible to appropriately arrange data in order to sufficiently receive benefits by dividing a storage location into layers.

For example, in the pay-as-you-go public cloud storage, the gateway stores the object in the column group with the high access frequency in the layer of which the storage fee is high and the access fee is low and stores the object in the column group with the low access frequency in the layer of which the storage fee is low and the access fee is high. As a result, it is possible to reduce usage cost that is a sum of storage cost and access cost.

### Second Embodiment

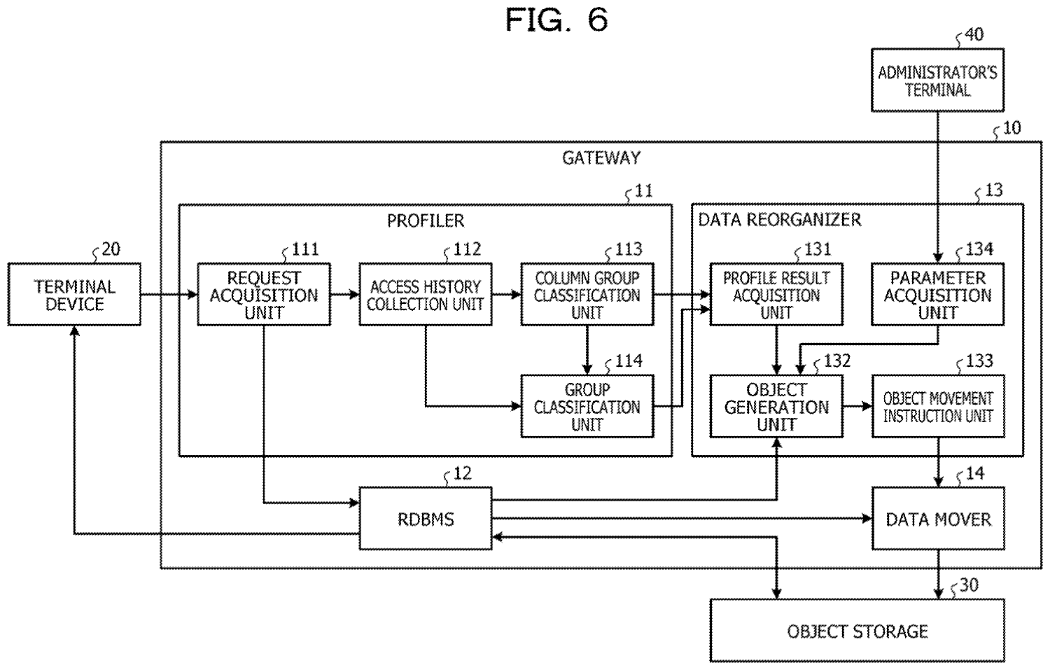

FIG. 6 is a block diagram illustrating details of a gateway according to a second embodiment. A gateway 10 according to the present embodiment is different from the first embodiment in that the gateway 10 groups column groups that have a high access frequency and are accessed at the same time into a more optimum division size and stores each group into an object storage 30 as a single object. In the following explanation, descriptions of functions of respective units similar to those of the first embodiment will be omitted.

A profiler 11 according to the present embodiment includes a group classification unit 114 in addition to the request acquisition unit 111, the access history collection unit 112, and the column group classification unit 113.

The column group classification unit 113 classifies each column of a database file 200 into a column group with a high access frequency and a column group with a low access frequency using an access history and an access frequency threshold of each column of the database file 200. Then, the column group classification unit 113 outputs information regarding the column group with the low access frequency to the profile result acquisition unit 131. Furthermore, the column group classification unit 113 outputs information regarding the column group with the high access frequency to the group classification unit 114.

The group classification unit 114 receives an input of the information regarding the column group with the high access frequency from the column group classification unit 113. Next, the group classification unit 114 acquires an access history of each column included in the column group with the high access frequency from the access history collection unit 112. Then, the group classification unit 114 analyzes the acquired access history and extracts and groups columns that are frequently accessed at the same time. For example, the group classification unit 114 groups columns using cluster analysis or the like. Thereafter, the group classification unit 114 outputs information regarding each group including information regarding a column which belongs to each group to the profile result acquisition unit 131.

For example, in a case of the database file 200 illustrated in FIG. 3, the group classification unit 114 generates two groups including a group of a column 201 represented by a diagonal line pattern and a group of a column 202 represented by a dot pattern.

A data reorganizer 13 according to the present embodiment includes a parameter acquisition unit 134 in addition to the profile result acquisition unit 131, the object generation unit 132, and the object movement instruction unit 133.

The profile result acquisition unit 131 receives an input of information regarding a column group with a low access frequency from the column group classification unit 113. Furthermore, the profile result acquisition unit 131 receives an input of information regarding each group of the grouped column groups with the high access frequency from the group classification unit 114. Then, the profile result acquisition unit 131 outputs, as a profile result, the information regarding the column group with the low access frequency and the information regarding each group of the grouped column groups with the high access frequency to the object generation unit 132.

The parameter acquisition unit 134 receives an input of information regarding a parameter including an optimum division size from an administrator's terminal 40. Here, the optimum division size represents a division size that maximizes a reading performance of the object storage 30 and is a division size that does not improve the reading performance even if the optimum division size is further divided into smaller size. For example, the optimum division size is obtained by measuring a file reading performance while changing the size of the file in the object storage 30 and the divided object size. The parameter acquisition unit 134 outputs the acquired parameter information to the object generation unit 132.

The object generation unit 132 receives an input of the profile result from the profile result acquisition unit 131. Furthermore, the object generation unit 132 receives an input of the parameter information from the parameter acquisition unit 134.

The object generation unit 132 divides the database file 200 for each column using the information regarding each column acquired from the DBMS 12 and collectively sets the columns with the low access frequency as a single object. Furthermore, the object generation unit 132 divides the database file 200 into each column using the information regarding each column acquired from the DBMS 12 and collectively sets the columns with the high access frequency as each group. Next, the object generation unit 132 divides each group into the optimum division size and sets each group as a single object.

Thereafter, the object generation unit 132 outputs an instruction for storing an object in the column group with the low access frequency in a second layer 32 to the object movement instruction unit 133. Furthermore, the object generation unit 132 outputs an instruction for storing each object generated by dividing each group in the column group with the high access frequency into the optimum division size in a first layer 31 to the object movement instruction unit 133.

The data mover 14 receives the instruction to store each object from the object movement instruction unit 133. Then, the data mover 14 stores the object in the column group with the low access frequency in the second layer 32 of the object storage 30. Furthermore, the data mover 14 stores an object generated by dividing each group in the column group with the high access frequency into the optimum division size in the first layer 31 of each object storage 30.

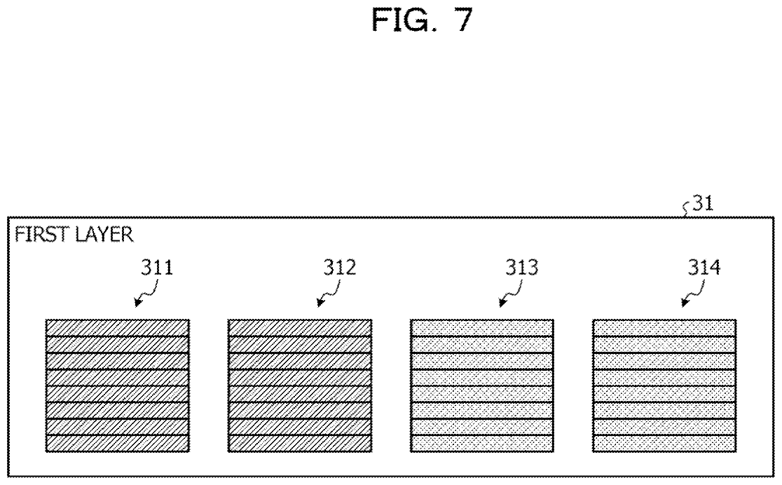

FIG. 7 is a diagram illustrating a storage state to a first layer of a database file according to the second embodiment. For example, in the database file 200 illustrated in FIG. 3, a group of the column 201 that has high access frequency and is frequently accessed at the same time is divided into objects 311 and 312 and is stored in the first layer 31. Furthermore, a group of columns 202 that has a high access frequency and is frequently accessed at the same time is divided into objects 313 and 314 and is stored in the first layer 31.

In this way, by grouping the columns that are frequently accessed at the same time and dividing the group into the optimum division size so as to form each one as a single object, reading of the plurality of columns in one access may be increased, and it is possible to reduce the number of accesses. Furthermore, reading may be performed with the number of parallel accesses that realizes an optimum reading performance, and the reading performance may be improved.

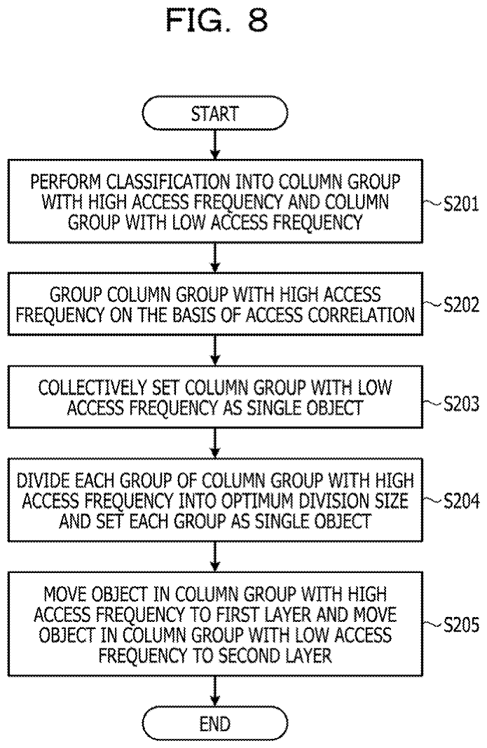

Next, with reference to FIG. 8, a flow of processing for storing the database file 200 in the object storage 30 by the gateway 10 according to the present embodiment will be described. FIG. 8 is a flowchart of storage processing to the object storage by the gateway according to the second embodiment.

The profile result acquisition unit 131 acquires an access frequency of each column from the access history collection unit 112. Then, the profile result acquisition unit 131 compares the access frequency and the access frequency threshold of each column and classifies the columns into columns having the high access frequency equal to or more than the access frequency threshold and columns having the low access frequency less than the access frequency threshold (step S201).

The group classification unit 114 receives an input of the information regarding the column group with the high access frequency from the column group classification unit 113. Next, the group classification unit 114 analyzes an access history of each column included in the column group with the high access frequency and groups the column on the basis of an access correlation (step S202).

The profile result acquisition unit 131 acquires the information regarding the column group with the low access frequency from the column group classification unit 113. Furthermore, the profile result acquisition unit 131 acquires the information regarding the grouped column group with the high access frequency from the group classification unit 114. The object generation unit 132 acquires a profile result including the information regarding the column group with the low access frequency and the information regarding the grouped column group with the high access frequency from the profile result acquisition unit 131. Then, the object generation unit 132 divides the database file 200 for each column using the information regarding each column acquired from the DBMS 12 and collectively sets the columns with the low access frequency as a single object (step S203).

Furthermore, the object generation unit 132 divides the database file 200 into each column using the information regarding each column acquired from the DBMS 12 and collectively sets the columns with the high access frequency as each group. Next, the object generation unit 132 divides each group into the optimum division size and sets each group as a single object (step S204).

The object generation unit 132 outputs information regarding an object including information indicating a column included in each object and information regarding a layer in which each object is arranged to the object movement instruction unit 133. The object movement instruction unit 133 instructs the data mover 14 to store each object in the designated layer. The data mover 14 moves the object in the column group with the high access frequency to the first layer 31 and moves the object in the column group with the low access frequency to the second layer 32 (step S205).

As described above, a storage system according to the present embodiment stores the grouped columns that are frequently accessed at the same time and are divided into the optimum division size in the first layer as a single object. As a result, it is possible to increase reading of the plurality of columns in one access, and it is possible to reduce the number of accesses.

Furthermore, there is a possibility that related art that stores the database file as one object does not have a reading performance. The object storage generally has a high parallel access performance and divides the same data into a plurality of objects and stores the objects and reads the objects in parallel at the time of reading so that the reading performance is improved. However, in a case where the entire file is stored as a single object, the number of parallel accesses is limited to one. Therefore, it is not possible to expect the improvement in the reading performance. In this way, with the traditional storage technique to the object storage, it has been difficult to improve the reading performance. On the other hand, in a case of the storage system according to the present embodiment, accesses that realize optimum reading performances may be performed in parallel, and the reading performance may be improved. Therefore, the storage system according to the present embodiment may read each group with the maximum reading performance while suppressing an increase in the number of times of reading and reading cost.

Moreover, by comparing the storage method according to the present embodiment with another storage method, an effect of the storage method according to the present embodiment will be numerically described. As described above, the storage system according to the present embodiment may read data with the maximum data reading performance from the object having the optimum division size. Therefore, in a case where data is read from the plurality of objects belonging to the single group, when it is assumed that the maximum reading performance according to the number of objects be b, it is possible to read the data with b. However, in a case where the different groups are read, the reading performance is limited to b that is the maximum reading performance of each group.

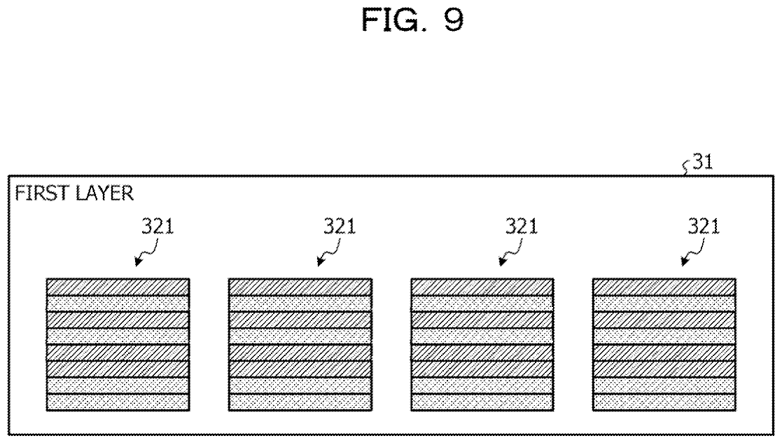

Here, as another method for dividing the database file into objects, for example, a method is considered for equally dividing a column group with a high access frequency into an optimum division size without considering a column group that is frequently accessed at the same time. FIG. 9 is a diagram illustrating a storage example in a case where a column group with a high access frequency is equally divided into an optimum division size to form an object. In this case, an object 321 includes data of columns that are accessed at the same time with a low frequency.

In a case of the layout in FIG. 9, a cost problem is caused. In the layout in FIG. 9, in a case where an entire column group with a high access frequency is read, reading may be performed at high speed, and it is possible to read the column group with b that is the maximum reading performance. However, because the access is actually performed in group units, reading performance of each group is deteriorated to (four columns)/(eight columns)×b=b/2 in a case of FIG. 9. Furthermore, there is a problem in that, because pieces of data of each group are distributed to all the objects 321, access to all the objects is performed to read each group, and the access cost increases.

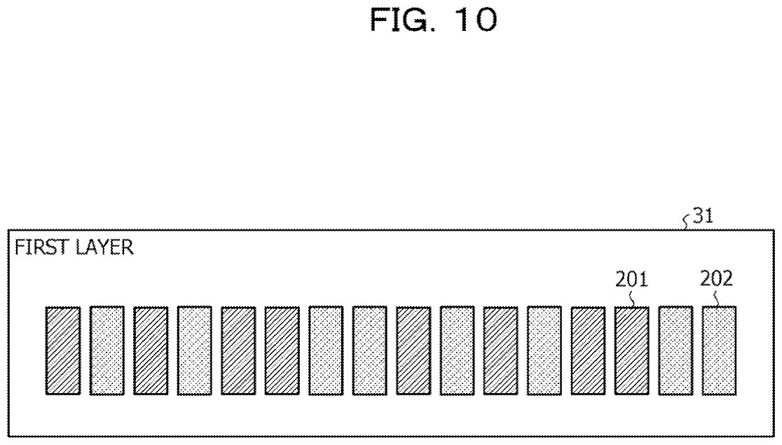

As another layout, each column may be regarded as one object. FIG. 10 is a diagram illustrating a storage example in a case where each column of a column group with a high access frequency is assumed as a single object. In FIG. 10, each of columns 201 and 202 with a high access frequency is individually stored in the first layer 31 as a single object. In this case, because the size of each column is smaller than the optimum division size, a reading performance of each group is b. However, in this case, in order to read each group, four times of accesses are performed as in a case of FIG. 9. Therefore, there is a problem in that access cost increases.

On the other hand, with the storage method according to the present embodiment, it is possible to read any group with two accesses that are a half of that in a case of FIGS. 9 and 10. Therefore, in a case of the storage method according to the present embodiment, it is possible to reduce the number of accesses and suppress access cost.

(Hardware Configuration)

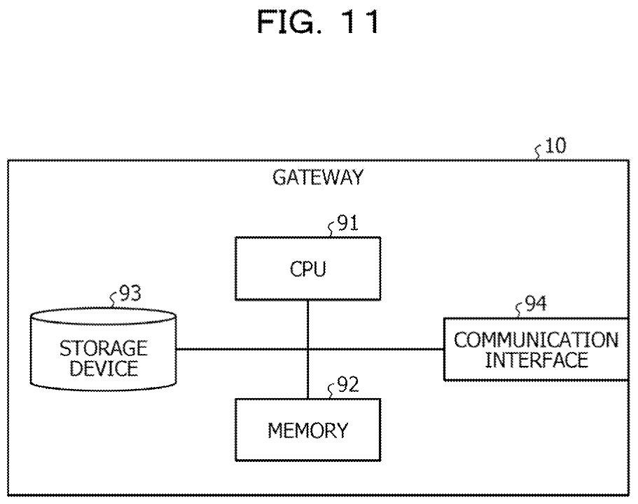

FIG. 11 is a diagram illustrating an example of a hardware configuration of a gateway. For example, as illustrated in FIG. 11, the gateway 10 includes a central processing unit (CPU) 91, a memory 92, a storage device 93, and a communication interface 94. The CPU 91 is mutually connected to the memory 92, the storage device 93, and the communication interface 94 with a bus.

The communication interface 94 is an interface that communicates between the gateway 10 and an external device. The communication interface 94 relays, for example, communication between the terminal device 20, the object storage 30, and the administrator's terminal 40 and the CPU 91.

The storage device 93 is, for example, a hard disk and a solid state drive (SSD). The storage device 93 stores various programs including programs for implementing the functions of the profiler 11, the DBMS 12, the data reorganizer 13, and the data mover 14 illustrated in FIGS. 1, 2, and 6.

The CPU 91 reads various programs from the storage device 93, develops the programs on the memory 92, and executes the programs so as to implement the functions of the profiler 11, the DBMS 12, the data reorganizer 13, and the data mover 14 illustrated in FIGS. 1, 2, and 6.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an information processing program for causing a computer to execute processing comprising:
classifying a database file into a plurality of datasets;
generating an object on the basis of the classified dataset; and
dividing and arranging each of the generated objects into layers that have different management conditions in an object storage.

2. The non-transitory computer-readable recording medium storing the information processing program according to claim 1, for causing the computer to execute processing further comprising:
acquiring an access history to each column of the database file; and
dividing the database file into the datasets to which a plurality of the columns belongs on the basis of the acquired access history.

3. The non-transitory computer-readable recording medium storing the information processing program according to claim 2, for causing the computer to execute processing further comprising:
representing each data included in the database file as a matrix and storing the continuous pieces of data for each column;
performing classification into a column group with a high access frequency of which an access frequency calculated on the basis of the access history is equal to or more than a predetermined threshold and a column group with a low access frequency of which the access frequency is less than the threshold;
arranging the object generated on the basis of the column group with the high access frequency in a first layer; and
arranging the object generated on the basis of the column group with the low access frequency in a second layer.

4. The non-transitory computer-readable recording medium storing the information processing program according to claim 2, for causing the computer to execute processing further comprising:
creating a plurality of groups by grouping the columns included in the dataset on the basis of an access correlation based on the access history; and
creating an object for each of the groups for the grouped dataset.

5. The non-transitory computer-readable recording medium storing the information processing program according to claim 4, for causing the computer to execute processing further comprising:
dividing each of the groups into a size that maximizes a reading performance in the object storage and setting each group as the object.

6. An information processing method comprising:
classifying, by a computer, a database file into a plurality of datasets;
generating an object on the basis of the classified dataset; and
dividing and arranging each of the generated objects into layers that have different management conditions in an object storage.

7. An information processing device comprising:
a memory; and
a processor coupled to the memory and configured to:
classify a database file into a plurality of datasets;
generate an object on the basis of the classified dataset; and
divide and arranging each of the generated objects into layers that have different management conditions in an object storage.
